(19) United States
(12) Patent Application Publication
(10) Pub. No.: US 2012/0089455 A1
(43) Pub. Date: Apr. 12, 2012

(54) SYSTEM AND METHOD FOR REAL-TIME ADVERTISING CAMPAIGN ADAPTATION

(76) Inventors: ESHWAR BELANI, San Jose, CA (US); Richard Frankel, San Francisco, CA (US); George John, Redwood City, CA (US)

(21) Appl. No.: 13/269,223

(22) Filed: Oct. 7, 2011

Related U.S. Application Data
(60) Provisional application No. 61/390,939, filed on Oct. 7, 2010.
(60) Provisional application No. 61/501,467, filed on Jun. 27, 2011.

(51) Int. Cl. G06Q 30/02

(52) U.S. Cl. 705/14.44

(57) ABSTRACT

A technique for adapting an advertising campaign based on real-time campaign metrics, such as a composition of the target audience among advertising recipients or an impact on brand metrics. As the advertising campaign runs, parameters of the campaign are updated to boost performance of a portion of the advertising campaign determined to be particularly effective by the campaign metrics. The campaign metrics utilize real-time, single-question surveys across segmented portions of the target audience, and then adapt the advertising campaign to target a particular segment based on desired brand and audience metrics.

### CROSS-REFERENCE TO RELATED APPLICATIONS

The present application for patent claims priority to Provisional Application Ser. No. 61/390,939, entitled “System and Method for Real-Time Brand Optimization,” filed Oct. 7, 2010, and to Provisional Application Ser. No. 61/501,467, entitled “System and Method for Real-Time Brand Optimization,” filed Jun. 27, 2011, both hereby expressly incorporated by reference herein.

### BACKGROUND

1. Field of the Invention

The present invention relates to the field of digital advertising and, in particular, to a system and method for real-time adaptation of brand advertising campaigns.

2. Description of the Related Art

Generally, brand advertisers conduct advertising campaigns to influence the preferences and behavior of an audience of consumers and increase impact relating to a brand metric (e.g. awareness, message recall, consideration, purchase intent, etc.) associated with a particular brand (e.g., a company's name, specific product, product family, service, etc.). This type of advertising, often referred to as “brand advertising,” is designed to raise awareness of, build affinity, and/or promote goodwill towards that particular brand. In contrast, “direct response” advertising is generally conducted to generate “leads”—prospective consumer interest—and/or sales, and to achieve other specific, quantifiable business results.

During a conventional brand advertising campaign, advertisers identify a target audience for advertising a specific product or service. Generally, the audience may be identified based on user demographics, lifestyles, attitudes, interests, past purchases, and/or hobbies. Advertisers can then launch an online advertising campaign to reach the target audience. However, these online campaigns tend to serve advertisements to individuals outside the target audience group that are not interested in the ads. Thus, conventional approaches to brand advertising incur inefficiencies in advertising costs.

During or after the advertising campaign is completed, advertisers may conduct polls to determine the effect of the advertising campaign on individuals, or measure “brand impact.” After analyzing the poll results, advertisers may want to make certain changes to the next ad campaign. To determine which changes to make, advertisers correlate campaign parameters (i.e., target audience, inventory sources, creative messaging, etc.) with the poll results, which may take several additional weeks and/or months. Latencies emerge during the many steps from initiating an advertising campaign to preparing for a next campaign run. Consequently, the parameters of the next ad campaign are determined based on lagging indicators from the previous campaign. Additionally, during this time, many changes in the marketplace may arise, such as the introduction of new products by competitors and/or changes in consumer behavior and/or preferences. Accordingly, there are challenges in managing an advertising campaign to reduce reliance on outdated and/or stale information.

In other cases, brand marketers have traditionally relied on click-through rates (CTR), or other “proxy” metrics typically utilized in direct response marketing, to determine whether an advertising campaign is reaching a desired audience or having the desired brand impact. However, metrics such as CTR, engagement, or conversion rates may provide misleading or sub-optimal results. A 2009 study by comScore indicates that the vast majority of users (over 80%) on the Internet generally don't click on online ads and 8% of the users (heavy clickers) account for 85% of all clicks. Focusing exclusively on CTR generally skews the campaign against the audience of heavy clickers and ignores the impact of the campaign on the vast majority of the audience. In addition, individuals that actively click on an ad, as positively accounted for by CTR, are generally people who are already aware of the brand or have an affinity towards it. Focusing on these users is sub-optimal as the campaign largely ignores users who aren't aware of the brand or have a low affinity towards it. Thereby, the incremental impact directly emanating from the campaign is marginalized. Clearly, such proxy metrics often do not help increase metrics that an advertiser cares about, such as awareness, message association, consideration, purchase intent, and other brand-focused metrics.

Accordingly, there remains a need in the art for a technique for managing online brand advertising campaigns that addresses the drawbacks and limitations discussed above.

### SUMMARY

Embodiments of the invention provide a technique for advertising campaign optimization based on real-time brand perception and audience characteristics. Embodiments of the invention first build a custom target audience profile based on the marketing objectives for each ad campaign by layering multiple types of data about consumers—including demographic, interest, lifestyle, purchase history, behavioral, contextual, social, and search data among others. As the ad campaign runs, embodiments of the invention dynamically measure campaign metrics, such as the campaign's impact on one or more brand metrics or composition of the target audience. In one implementation, the campaign metrics are measured using real-time, single-question survey data to determine the characteristics of those most likely to exhibit positive responses to the campaign or to verify audience characteristics of the recipients desired by the advertiser. Embodiments of the invention then optimize the targeting for the campaign based on the brand and audience metrics.

Embodiments of the invention provide a method for implementing a brand-based ad campaign. The method generally includes providing advertising to a plurality of users based on one or more campaign parameters and providing one or more survey queries to the plurality of users, wherein the survey queries are selected to measure one or more campaign metrics. The method further includes processing, by operation of one or more processing units, responses to the survey queries to update the one or more campaign parameters based on the measured campaign metrics.

Embodiments of the invention provide a method for executing an advertising campaign to an audience comprising a plurality of users. The method generally includes processing a plurality of user responses to generate one or more campaign metrics, wherein the plurality of user responses are responsive to one or more survey queries provided to the plurality of users, and modifying, by operation of one or more processing units, one or more campaign parameters of the advertising campaign based on the generated campaign metrics.

Embodiments of the invention provide a method for adapting an advertising campaign. The method generally includes determining an audience segment for a user (which could be based on user demographics, lifestyles, interests, past purchases, etc.; or the ad inventory context; or a creative message; or any other segmentation scheme) selecting an ad for the user based on the audience segment and/or on one or more campaign parameters, and selecting a survey query to provide to the user. The method further includes processing, by operation of one or more processing units, a response to the survey query using the audience segment to generate one or more campaign metrics and updating at least one of the campaign parameters based on the one or more campaign metrics.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computing system configured for delivering online advertising, according to one embodiment of the invention.

FIG. 2 is a more detailed view of an ad server of FIG. 1 within which embodiments of the invention may be implemented.

FIG. 3 depicts an exemplary web page document having online advertising provided by techniques according to certain aspects of the present disclosure.

FIG. 4 is a flow diagram of method steps for operating a brand advertising campaign having real-time adaptation, according to certain aspects of the present disclosure.

FIG. 5 illustrates an example real-time survey displayed in the web page document of FIG. 3, according to certain aspects of present disclosure.

FIG. 6 is a block diagram of a system providing online advertising to a user, according to certain aspects of present disclosure.

FIG. 7 illustrates an example operation for adapting an online advertising campaign based on targeting effectiveness, according to certain aspects of present disclosure.

FIG. 8 illustrates an example operation for adapting an online advertising campaign based on ad effectiveness, according to certain aspects of present disclosure.

FIG. 9 is a flow diagram of method steps for serving brand advertising to a user utilizing a technique for real-time adaptation based on targeting effectiveness, according to certain aspects of the present disclosure.

FIG. 10 is a flow diagram of method steps for serving brand advertising to a user utilizing a technique for real-time adaptation based on ad effectiveness, according to certain aspects of the present disclosure.

### DETAILED DESCRIPTION

Embodiments on the invention provide a technique for online advertising utilizing real-time survey analysis to adapt parameters of an advertising campaign to better achieve the marketing objectives of the campaign. In addition to being shown ads of the advertising campaign, users are presented with a survey query, such as a single question survey, used to measure audience or brand metrics. Responses from the surveys are collected and analyzed in real time to adapt the advertising campaign while the campaign is ongoing. Embodiments of the invention provide techniques for adapting the campaign parameters to improve targeting effectiveness (based on measured audience metrics) or to improve ad effectiveness (based on measured brand metrics).

Embodiments of the invention may be provided to adapt one or more campaign parameters to improve how well an advertising campaign reaches a target audience amongst the recipients of the advertising campaign, referred herein as “targeting effectiveness.” According to one embodiment, targeting effectiveness may be employed when a campaign is focused on a well-qualified target audience with distinct attributes. The target audience may be qualified based on a variety of attributes, including, but not limited to, demographics, lifestyles, behaviors, interests, occupations, and “in-the-market-for” intent. As such, increasing composition of the target audience within the actual recipients of the advertising campaign may have a positive brand impact. To measure target effectiveness, embodiments of the invention may select a survey question focused on an attribute that is associated with a target audience.

Embodiments of the invention may be provided to adapt one or more campaign parameters to improving a brand metric, such as brand impact, associated with the product/service being advertised, referred herein as “ad effectiveness.” According to one embodiment, ad effectiveness may be employed when an advertising campaign is focused on a broad audience. The advertising campaign's objective may relate to improving a brand metric associated with the product or service being advertised. The brand metrics include, but are not limited to, an awareness of the existence of a product or service (i.e., brand awareness), an ability of a customer to remember a particular branding message (i.e., “message recall”), a customer's favorability towards a particular product or service (i.e., “affinity”), an intent of the customer to purchase a product or service (“purchase intent”), and/or a customer's active consideration of a product or service, e.g., through demonstrations or test-drives (i.e. “consideration.”) To measure ad effectiveness, embodiments of the invention may select a survey query related to the product and/or service and the brand metric of interest.

In one embodiment, recipients of an advertising campaign may be grouped into a plurality of different “audience segments.” An audience segment generally refers to one or more users that represent a targeting tactic, a grouping based on one or more user characteristics such as demographics, lifestyles, interests, in-market intent, etc., a creative ad unit, a category of advertising inventory, the type of channel by which a user receives content, a collection of sites, or other suitable partitioning schemes. While an audience segment generally contains multiple users, in some embodiments, an audience segment may represent a single user (“segment of one”). As the campaign runs and survey responses are collected across segments, poorly performing segments (as determined by the campaign metrics) may be scaled down while impression delivery to the best-performing segments is increased.

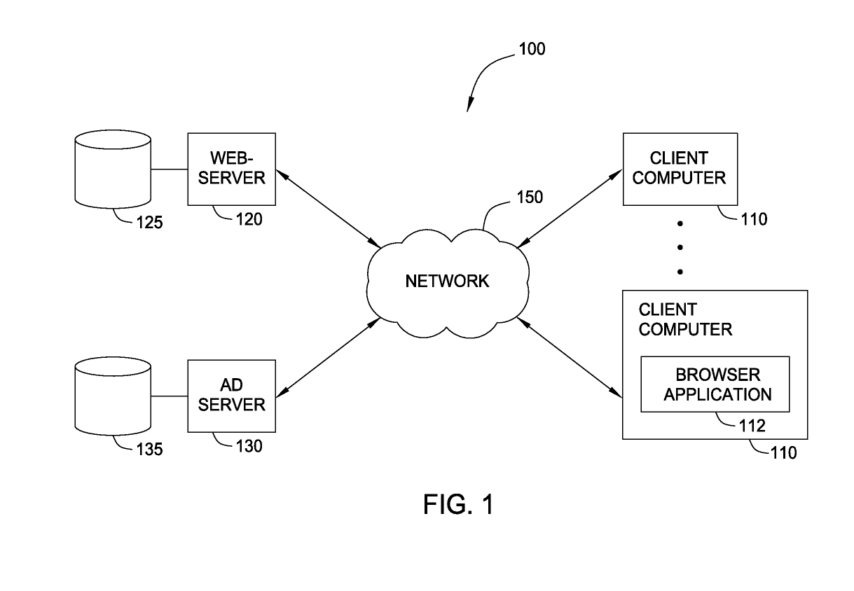

FIG. 1 illustrates a computing system 100 configured for delivering online advertising, according to one embodiment of the invention. As shown, the computing system 100 includes a web server 120, an ad server 130, and a plurality of client computers 110 (only two of which are shown for clarity), each connected to a communications network 150 (e.g., the Internet). For example, the web server 120 may be programmed to communicate with the client computers 110 and the ad server 130 using a networking protocol such as TCP/IP protocol.

Each client computer 110 may include conventional components of a computing device, e.g., a processor, system memory, a hard disk drive, input devices such as a mouse, touchscreen, and a keyboard, and/or output devices, such as a monitor. The web server 120 includes a processor and a system memory (not shown), and may be configured to manage web pages and other media content stored in its respective content storage unit 125 using a file system and/or a relational database software. The ad server 130 is similar to a web server except that it is configured to manage advertising content stored in its respective content storage unit 135. In one embodiment, the ad server 130 may be configured to manage an advertising campaign utilizing techniques described herein and is described in further detail below.

In the embodiments of the present invention described below, users are respectively operating the client computers 110 that may communicate over the network 150 to request web pages and other media content data from the web server 120. Each client computer 110 may be configured to execute a software application, such as a web browser application 112, and access web pages and/or media content data managed by the web server 120 by specifying a uniform resource locator (URL) for the web server 120 into the web browser application 112. The web pages that are displayed to a user are transmitted from the web server 120 to the user's client computer 110 and processed by the web browser application 112 for display through a monitor of the user's client computer 110.

In one embodiment, the web pages may contain an instruction, often referred to as an “ad tag,” to request advertising content from the ad server 130. In response to processing a web page having an ad tag, the web browser application 112 may be programmed to request advertising content from the ad server 130. The web browser application 112 may receive the advertising content and display the advertising to the user through the monitor of the user's client computer 110. In one embodiment, the web browser application 112 may display the advertising inline and/or integrated with the requested web page content.

It is noted that the client computer 110 may be a personal computer, laptop, mobile computing device, smart phone, video game console, home digital media player, network-connected television, set top box, and/or other computing devices having components suitable for communicating with the communications network 150. The client computer 110 may also execute other software applications configured to receive advertising content from the ad server 130, such as, advertising-supported software (“adware”), computer and video games, media players, and/or widget platforms.

Further, while the ad server 130 is depicted as a single entity in FIG. 1 for sake of discussion, it is understood that the ad server 130 represents an ad-delivering system that may be implemented using a variety of architectures and configurations having multiple components, modules, and/or servers in communication. For example, the ad-delivering system may include ad-delivering servers, ad exchanges, demand side platforms (DSPs), ad networks (horizontal and vertical), analytic platforms, real-time bidding platforms, data management platforms, data aggregators, dynamic creative optimization systems, ad verification systems, targeted and behavioral advertising platforms, and/or other campaign management systems. For example, in one embodiment, the ad server 130 may include a campaign server configured to direct or instruct a third-party component or server configured for ad delivery to transmit ad content to the user or customer. The campaign server may be further configured to perform one or more techniques for real-time advertising campaign adaptation as described herein. Alternatively, for clarity, the campaign server may be considered a component of the ad server 130 in the detailed description below.

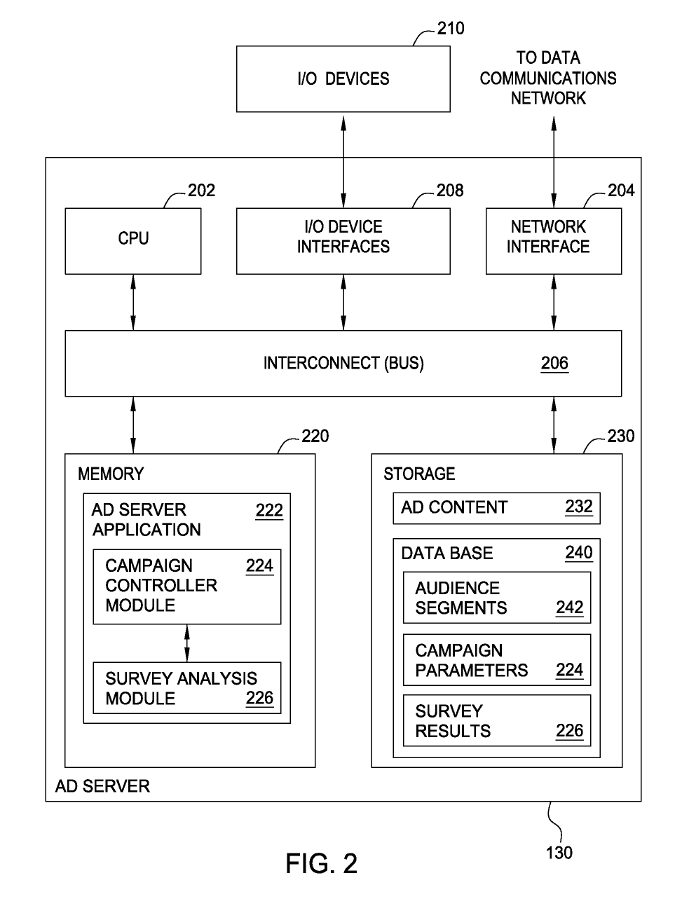

FIG. 2 is a more detailed view of the ad server 130 of FIG. 1 within which embodiments of the invention may be implemented. As shown, the ad server 130 includes, without limitation, a central processing unit (CPU) 202, a network interface 204, memory 220, and storage 230 communicating via an interconnect bus 206. The ad server 130 may also include I/O device interfaces 208 connecting I/O devices 210 (e.g., keyboard, video, mouse, audio). The ad server 130 may further include a network interface 204 configured to transmit data via the communications network 150.

The CPU 202 retrieves and executes programming instructions stored in the memory 220 and generally controls and coordinates operations of other system components. Similarly, the CPU 202 stores and retrieves application data residing in the memory 220. The CPU 202 is included to be representative of a single CPU, multiple CPUs, a single CPU having multiple processing cores, and the like. The interconnect bus 206 is used to transmit programming instructions and application data between the CPU 202, I/O devices interface 208, storage 230, network interface 204, and memory 220.

The memory 220 is generally included to be representative of a random access memory and, in operation, stores software applications and data for use by the CPU 202. Although shown as a single unit, the storage 230 may be a combination of fixed and/or removable storage devices, such as fixed disc drives, floppy disc drives, hard disk drives, flash memory storage drives, tape drives, removable memory cards, CD-ROM, DVD-ROM, Blu-ray, HD-DVD, optical storage, network attached storage (NAS), or a storage area-network (SAN) configured to store non-volatile data.

According to embodiments of the invention, the memory 220 stores instructions and logic for executing an ad server application 222. Amongst other modules, the ad server application 222 includes a campaign controller module 224 and a survey analysis module 226. The storage 230 stores ad content 232 and includes a database 240 configured to store data for executing an advertising campaign according to techniques described herein, such as audience segments 242, campaign parameters 244, and survey results 246. The ad server application 222 responds to requests from clients, such as the web browser application 112, for advertising content. In one embodiment, the database 240 comprises a relational database. In another embodiment, the database 240 is any type of storage device.

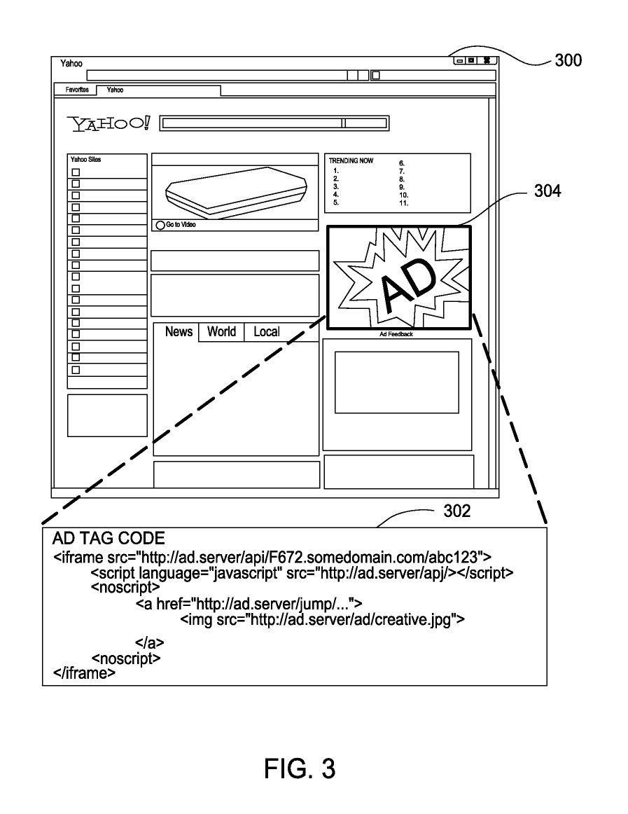

As discussed above, a user may utilize a web browser application 112 to request and access web pages and/or other content from the web server 120. FIG. 3 depicts an exemplary web page document 300 having online advertising provided by techniques according to certain aspects of the present disclosure. The web server 120 may generate the web page document 300. As shown, the web page document 300 includes ad tag code 302 that provides instructions for the web browser application 112 to request advertising content 304 from the ad server 130 when the web page document 300 is processed by the web browser application 112. In one embodiment, the web server 120 and ad server 130 may communicate to coordinate and manage advertising content to be provided to the client computers 110.

Generally, ad tag codes 302 may be implemented as snippets of code or scripting language, such as, Hypertext Markup Language (HTML) or JavaScript, that request the service of advertising content. The ad tag codes 302 may include a reference such as a URL from where the ad content may be requested. In one embodiment, the ad tag code 302 includes a URL having pre-defined parameters encoded in the URL string. In the example shown in FIG. 3, the ad tag code 302 includes programming code that indicates advertising content for the web page document 300 may be requested at the URL seen below:

http://ad.server/api/F672.somedomain.com/abc123

In one embodiment, the web server 120 may generate an ad tag code 302 that is individually configured for a particular client computer 110 or end user. The ad tag code 302 may include an identifier associated with a particular client computer 110 or user. The web browser application 112 may request advertising content from the ad server 130 utilizing the identifier to receive advertising content targeted towards that particular client computer 110 or user. For example, the identifier may comprise a unique string of characters in the URL, such as the string “F672.somedomain.com/abc123” seen in the URL above. As such, the ad server 130 may determine the identity of a client computer 110 or user based on the unique URL used to request advertising content.

The web browser application 112 is programmed to request and receive the advertising content 304 from the ad server 130. As shown in FIG. 3, the web browser application 112 incorporates the advertising content 304 into the web page document 300 and displays such to the user. The advertising content 304 from the ad server 130 may be display advertising or interactive advertising and may be presented in various forms of media content, including but not limited to, graphical images, video and audio content, text, and/or embedded scripting logic. According to embodiments described below, the advertising content 304 may include an interactive feedback feature, such as a survey questionnaire, single question survey, or a means to track user engagement with the advertising unit.

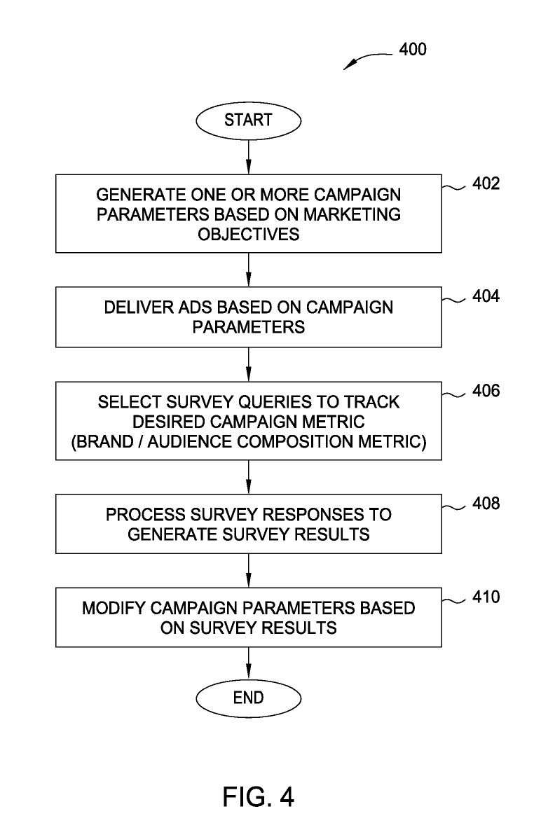

The operations of the ad server are more fully described in FIG. 4. Specifically, FIG. 4 is flow diagram of method steps for operating a brand advertising campaign supporting real-time adaptation, according to one embodiment of the invention. Persons skilled in the art will understand that, even though the method 400 is described in conjunction with the systems of FIGS. 1-2, any system configured to perform the method steps, in any order, is within the scope of embodiments of the invention.

As shown, the method 400 begins at 402, where the ad server 130 generates one or more campaign parameters of an advertising campaign based on marketing objectives. Generally, an advertising campaign may be defined by one or more campaign parameters selected to achieve one or more marketing objectives. The campaign parameters may include a number of instances for ad content to be served (sometimes referred to as “impressions”), a duration of time in which to execute the advertising campaign (e.g., weeks, months), a certain revenue budget associated with the campaign, a targeted audience to whom the advertising campaign is to be delivered, targeting tactics and strategies, predictive models, and/or other advertisement settings. In some embodiments, the one or more campaign parameters are based on maximizing audience composition and/or optimizing an overall lift in a given brand metric.

Generally, the advertising campaign may target a specific audience of users. In one embodiment, the targeted audience may be represented as an audience profile having one or more targeted characteristics, or as a list of known user identifiers associated with user profiles having the one or more targeted characteristics of the audience profile. The target audience may be selected based on layering multiple types of data about consumers, including demographics, business demographics (sometimes referred to as “bizographics”), social, social psychographics, interests, lifestyle, behavioral, contextual, purchase history, offline purchase data, and search history. The target audience may also be selected from an “in-the-market-for” audience, for example, for users with demonstrated interest in automobile, financial services, education, travel, medical, retail markets, or in markets by dint of their search intent. In another embodiment, the target audience may be selected based on contextual content categories such as news, sports, entertainment, lifestyles, financial, technology, and others. Additionally, in another embodiment, the target audience may be based on the advertising media channel. Embodiments of the invention may layer multiple unique data sources with a unique suite of targeting algorithms, analytics, automation, and analysis to generate a target audience having a high composition. In some embodiments, an initial target audience may simply be the entire general population at random.

According to embodiments of the invention, the target audience may be partitioned into one or more audience segments. Each audience segment may be further characterized by one or more audience characteristics described above, such as by demographics, lifestyles, interests, content categories, creative messages, media channels, time of the day, search intent, social, past purchases, behavioral data, geographic data, panel lookalikes, browsing activity, and other attributes. Embodiments of the invention may utilize the one or more audience segments to analyze the effectiveness of the advertising campaign upon the target audience with a finer granularity. In one embodiment, one or more campaign parameters may include settings that allocate an initial number of impressions to be served to a particular audience segment.

At 404, the ad server 130 delivers ads to users based on the campaign parameters, and the advertising campaign begins running. In one embodiment, the ad server 130 provides advertising to a plurality of users based on the one or more campaign parameters. In some embodiments, ads are delivered to users based on whether a given user matches the targeted audience of the advertising campaign.

During the ad campaign, at 406, the ad server 130 selects survey queries to track a desired campaign metric (e.g., brand metric, audience composition metric). In one embodiment, the ad server 130 provides one or more survey queries to the plurality of users, wherein the survey queries are selected to measure one or more campaign metrics. Generally, the survey queries allow embodiments of the invention to adapt while the campaign is ongoing to maximize the impact of the campaign. The ad server 130 is configured to optimize the campaign by analyzing survey responses and by scaling an advertising campaign (i.e., increase/decrease impressions) for a given audience segment appropriately after a statistically significant number of responses have been collected for each segment.

Other embodiments of the invention can leverage user actions such as engagement with the advertising unit, the user's dwell time with the advertising unit, or the time for which the advertising unit was visible as being representative measures for brand metrics.

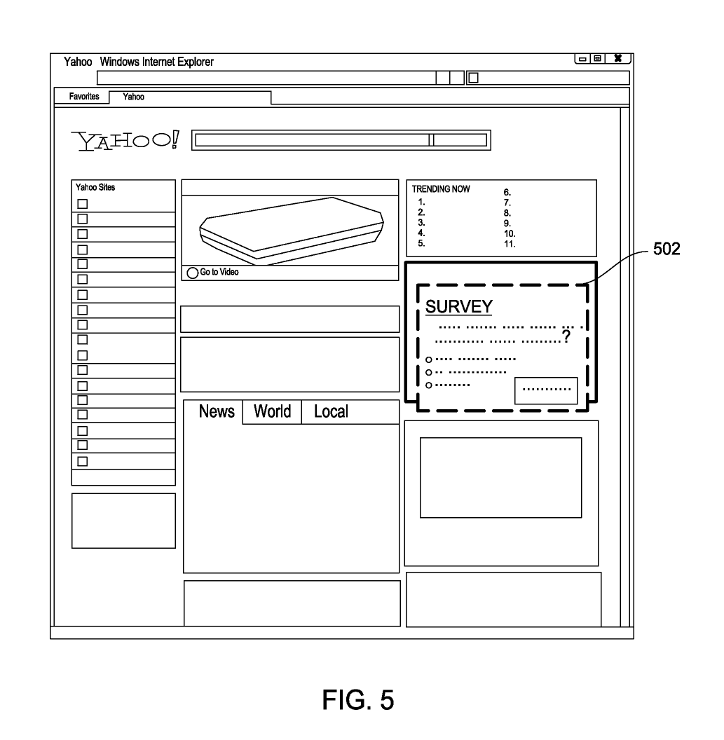

FIG. 5 illustrates an example real-time survey 502 displayed in the web page document 300 of FIG. 3, according to embodiments of the invention. The real-time survey 502 may be customized by the advertiser to measure various campaign metrics. The real-time survey 502 may be configured to test “target effectiveness” (i.e., whether the advertising campaign is reaching the intended target audience) or “ad effectiveness” (i.e., whether the advertising campaign is having an impact relative to a particular brand metric), as described in further detail below.

As shown in FIG. 5, the real-time survey 502 is a single-question survey having at least one specific question and a corresponding, pre-determined list of survey responses. In some embodiments, a real-time survey may have two response options, including a positive option (e.g., “yes”) and a negative option (e.g., “no”). Embodiments of the invention may track the responses to the survey in an effort to drive more positive responses. In another embodiment, the real-time surveys may support multiple positive responses and/or responses and may have different values associated with them with regard to their impact. For example, a survey question may ask “How often do you shop at store X?” One example of possible responses includes, (a) daily, (b) once a week, (c) once a month, or (d) less than once a month. In one implementation, any one of responses (a), (b), or (c) may be considered a positive response. However, in some implementations, response (a) has a greater weight than response (b), which has a greater weight than response (c). Other examples of survey questions include “Which of the following brands have you heard of?”, “Which brand of [category] is known for [message]?”, “How likely are you going to consider [brand] for your next purchase of [category]?”, “Which of the following attributes best describe your opinion about [brand]?”, and “Would you recommend [brand]?” While the real-time survey 502 is depicted in FIG. 5 as a single-question survey, multiple survey questions and other interactive survey formats may be utilized.

In at least some embodiments, the real-time survey 502 may further include one or more questions configured to capture audience information from the user. For example, the real-time survey 502, in addition to queries related to ad or targeting effectiveness, may include one or more questions regarding the user's demographics, such as sex, age, and/or geographic location.

The real-time survey 502 may be displayed and/or delivered in a variety of configurations. In the embodiment shown in FIG. 5, the real-time survey 502 is delivered to the user concurrently with the ad content 304 and is displayed overlaid or in place of the ad content 304 (sometimes referred to as an “in-situ survey”). The real-time survey 502 may be configured to have a similar dimension to the ad content 304 provided by the ad server 130 and/or may have a size selected from conventional ad sizes such as the Ad Unit Guidelines provided by the Interactive Advertising Bureau (IAB) or any other size. In some embodiments, the real-time survey 502 may be prominently displayed to the user, such as in a modal window format.

While real-time surveys 502 may be discussed hereinafter as in-situ surveys for clarity of discussion, it is noted that embodiments of the invention may be extended for other configurations of the real-time survey 502. For example, in one alternative embodiment, the real-time survey 502 may be displayed to the user after a predetermined period of time after the ad content 304 has been provided to the user. The predetermined period of time may be selected as a period of time sufficient to allow impact from the ad content 304 on an exposed user to take hold, but less than period of time in which the impact may decay. In some implementations, the predetermined period of time is selected from several days to a month. In another embodiment, the real-time survey 502 may be displayed to the user after a threshold amount of exposure to ad content 304 has been reached. For example, the real-time survey 502 may be delivered to any user after it has been determined that the user has been delivered at least three impressions of the ad content 304.

Returning to FIG. 4, at 408, the ad server 130 processes responses to the survey queries to generate survey results. The survey results generally indicate the effectiveness of the advertising campaign in relation to achieving its marketing objectives. In some embodiments, other metrics like user engagement and dwell time can be used instead of surveys to gauge the impact on brand metrics.

At 410, the ad server 130 modifies campaign parameters based on the survey results to adapt the advertising campaign in real-time. In one embodiment, step 410 is performed by the campaign controller module 224 included in the ad server 130. As such, as the ad server 130 continues to execute the now-refined advertising campaign, and subsequent users are provided ad content based on the one or more modified campaign parameters.

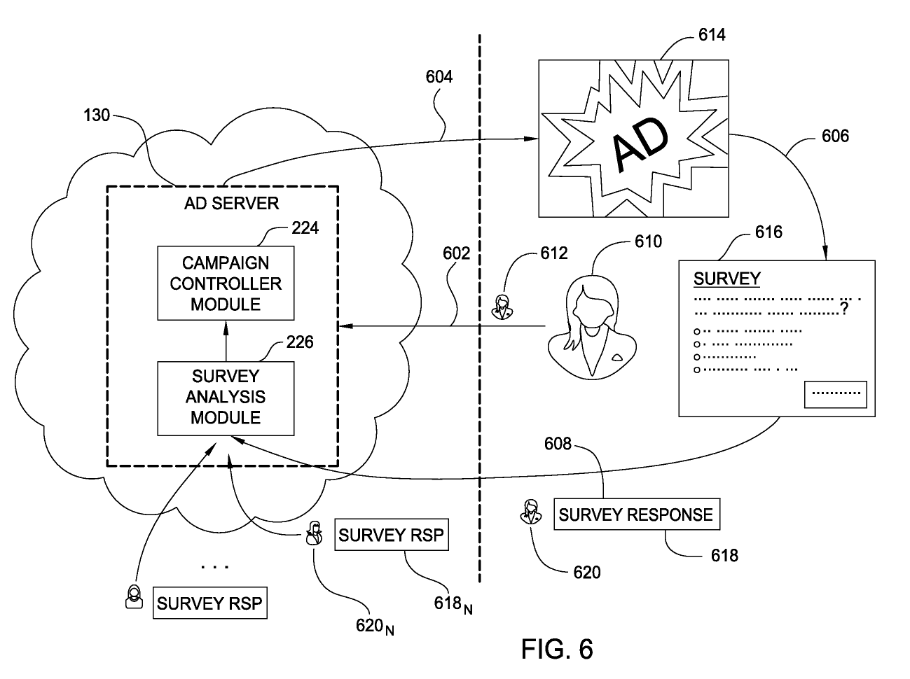

FIG. 6 is a block diagram depicting an example operation for executing an online advertising campaign utilizing real-time campaign adaptation, according to one embodiment of the invention. As shown, at 602, responsive to an ad tag, a client computer 610 associated with a user requests ad content from the ad server 130 in a manner that indicates an identifier 612 of the user. In one embodiment, the client computer 610 requests ad content utilizing a URL that was specifically generated for the user and that may be encoded with data parameters. The ad server 130 receives the request and determines ad content to provide to the client computer 610 based on the identifier 612 of the user. In addition, other data such as the site, content category, time of the day, user data, and other information may be used to determine the ad content. In some embodiments, the ad server 130 may determine ad content for the client computer 610 based on whether the user is a member of the target audience. As noted above, the targeted audience may be represented as a list of known user identifiers, such as the identifier 612, associated with a user profile having one or more targeted characteristics described below. In one implementation, the user identifiers 612 may correspond to a persistent session identifiers, such as provided by HTTP cookies.

According to embodiments of the invention, the ad server 130 determines and selects ad content from an advertising campaign being managed by the campaign controller module 224. As shown at 604, the ad server 130 selects and provides ad content 614 associated with the advertising campaign to the user based on the one or more campaign parameters that indicate the user 610 among a target audience of the advertising campaign.

After serving the ad content, in one embodiment, the user is then provided with a real-time survey 616 to measure one or more campaign metrics, as shown at 606. In one implementation, the impact on the campaign metric may be measured using real-time, single-question survey data to determine the characteristics of those most likely to exhibit the brand responses or audience characteristics desired by the advertiser.

At 608, the user completes the survey 616 and the survey response 618 is provided to the survey analysis module 226. The survey response 618 includes information sufficient to associate each survey response with a given advertising campaign and with a given user in an audience segment. In some embodiments, the survey response 618 may include a question identifier, a response identifier, and optionally a survey partner user identifier. As illustrated, the survey response 618 is accompanied by a user identifier 620. Additionally, a plurality of responses 618_{N} with corresponding user identifiers 620_{N} from other users may be transmitted to the survey analysis module 226.

In some embodiments, the real-time survey content and survey responses may be provided and processed by a third-party survey partner, entity, or component. In some embodiments, the ad server 130 may provide a “survey tag” to the user. Similar to an ad tag discussed above, the survey tag comprises instructions for requesting survey content from a third-party survey partner. In some embodiments, the user may be configured to process the survey tag, request, and receive the survey content from the third-party survey partner. Additionally, the submission of the survey response may be made to the third-party survey partner, who shares the survey responses for delivery in real-time to the survey analysis module 226.

As noted above, the survey analysis module 226 processes the survey responses to generate values for one or more campaign metrics. The values of the campaign metrics may indicate the effectiveness of the particular advertising campaign with regards to a given user or audience segment. In some embodiments, the value of the campaign metric measures the targeting effectiveness or the ad effectiveness of the advertising campaign, as described in further detail below. As noted above, the campaign controller module 224 utilizes the campaign metrics to modify one or more campaign parameters to execute the advertising campaign and more effectively achieve marketing objectives.

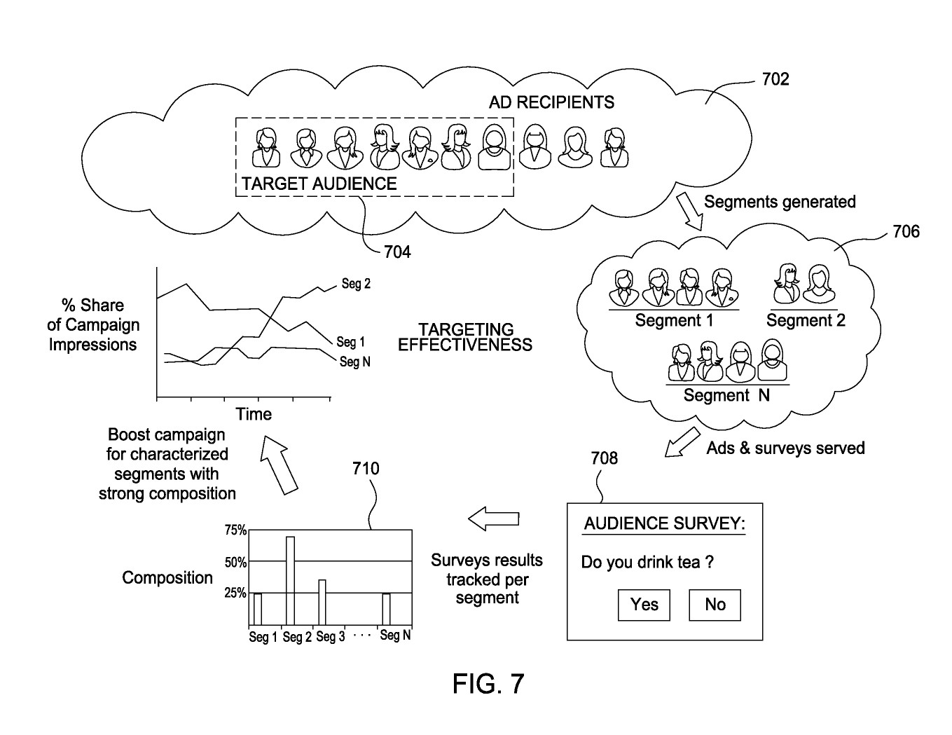

FIG. 7 illustrates one embodiment of the invention for adapting an online advertising campaign utilizing real-time surveys to measure targeting effectiveness of the campaign, according to one embodiment of the invention. User profiles such as those generated from user data, content sites, or other sources may only be an estimate or prediction of each user's actual demographics, preferences and behavior. This imprecision may lead to discrepancies between recipients 702 of the advertising campaign and the target audience 704 (i.e., users actually having a specific audience characteristic of the target audience). For example, an advertising campaign may seek to target consumers that drink tea, but a generated dataset of users (e.g., provided from a third party data provider or other sources) may include users that instead prefer coffee or that dislike or don't drink tea.

As such, the adaptation of the campaign based on targeting effectiveness is focused on increasing a composition of the target audience amongst recipients of the advertising campaign. In some embodiments, the brand impact of a campaign may be related and/or proportional to the composition of the target audience reached. For example, a campaign having an 80% composition (i.e. 80% of the ad impressions reach the target audience 704 with the right frequency) may have about twice the impact as a campaign with 40% composition.

In one embodiment, targeting effectiveness may be improved by grouping the users reached by a campaign into different segments and measuring the composition of each segment. As illustrated, the ad campaign recipients 702 are partitioned into N audience segments 706. Audience segments may be generated based on a variety of factors, including, marketing tactics, externally-provided data segments, categories of inventory (i.e., web pages), predictive model based lookalikes, creative ad units, and other approaches.

As illustrated, ad content and real-time surveys 708 are served for each audience segment 706. In one embodiment, the real-time survey 708 may be customized to measure an attribute that is associated with the target audience 704. In one embodiment, the survey responses are tracked per audience segment 706 in real-time.

According to some embodiments, a subset of the target audience may be surveyed (i.e., the target audience may be sampled). As such, changes to the ad campaign are not performed until a statistically significant number of measurements are made to determine audience composition of a given segment. In other words, a statistically significant number of survey responses may be received to allow for a certain confidence level that the adaptation to the campaign shall favorably increase the values of the desired metrics. An audience segment 706 is deemed to have been “characterized” after a statistically significant number of responses have been collected for the given segment. Characterized segments may be associated with a composition score and statistical parameters such as a confidence level and error rate.

As the advertising campaign is executed, the campaign may be adapted, or optimized, in real time to deliver impressions to audience segments based on their corresponding composition scores. In one embodiment, the campaign may be adapted to deliver an increased number of impressions to segments with higher composition scores (sometimes referred to as “scale up”). Embodiments of the invention provide ad impressions for audience segments more likely to contain a user in the target audience, thereby improving the effectiveness of the advertising campaign. If new audience segments are added to the campaign, each audience segment may be characterized and then scaled as appropriate. Additionally, characterized segments that are being scaled up may be continuously be monitored to ensure that the composition of the audience segments remains high.

For instance, using the earlier example, the real-time survey 708 may ask each user “Do you drink tea?” in order to measure a composition of the ad recipients 702 that are tea drinkers. Each audience segment 706 is then surveyed to gauge its composition of tea drinkers. The survey responses are aggregated per audience segment and a metric is generated that indicates a proportion of the audience segment (i.e., composition) that drinks tea. As shown at 710, one audience segment (e.g., Segment 2) has a strong composition of tea drinkers. Accordingly, over time, the impact of the advertising campaign is improved, by the allocation of an increased percentage share of campaign resources, for audience segments corresponding to higher composition scores (e.g., Segment 2.) In one embodiment, the advertising campaign is configured to deliver an increased percentage share of campaign ad impressions to users associated with audience segments having a higher composition score.

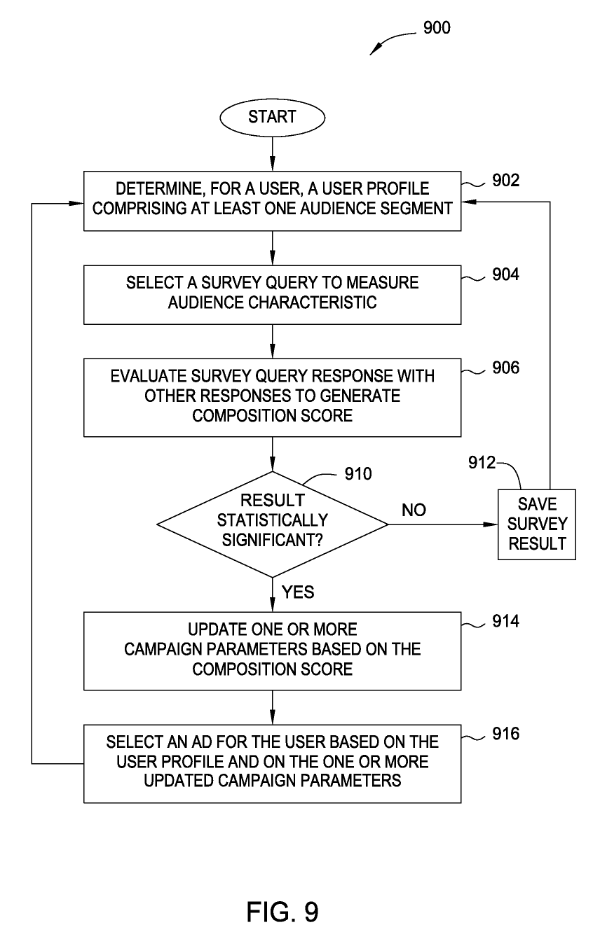

The example operations of the ad server 130 for adapting an online advertising campaign based on targeting effectiveness are discussed in greater detail in FIG. 9. FIG. 9 is a flow diagram of method steps 900 for serving brand advertising to a user utilizing a technique for real-time adaptation based on targeting effectiveness, according to certain aspects of the present disclosure. Persons skilled in the art will understand that, even though the method 900 is described in conjunction with the systems of FIGS. 1-2, any system configured to perform the method steps, in any order, is within the scope of embodiments of the invention.

As shown, the method 900 begins at 902, where the ad server 130 determines, the user profile for a given user, identifies the audience segment associated with the user. Each of a plurality of users may be assigned to a given audience segment to allocate resources of the advertising campaign with a fine degree of granularity. As described above, a user may be associated with an audience segment based on a variety of factors, including, marketing tactics, externally-provided data segments, categories of inventory (i.e., web pages), channels of communication, predictive model based lookalikes, creative ad units, media channel, and other approaches.

While audience segments associated with users may partition the plurality of users based on a variety of factors, it is appreciated that an advertising campaign may seek to reach particular users having an audience characteristic that may be only estimated by audience segmentation, if at all. Accordingly, at 904, the ad server 130 selects a survey query to measure one or more audience characteristics. The one or more audience characteristics may reflect habitual behavior of the user (e.g., “Do you drink tea?”), future behavior (e.g., “Are you planning to move within the next 90 days?”), and other user characterizations that may or may not be readily available from conventional data and/or approaches known in the art. In one embodiment, the survey query may be pre-determined and stored in a storage unit of the ad server 130. In one embodiment, the survey query is provided to the user using one or more delivery mechanisms described above.

At 906, the ad server 130 receives a survey query response from the user. The ad server 130 then evaluates the response to the survey query with other survey responses received from other users in the user's audience segment to generate a survey result comprising a composition score. In one embodiment, the composition score is a metric that represents a statistically determined proportion of the audience segment having a target audience characteristic. For example, a particular user in an audience segment having a composition score of 80% has an 80% chance of having a desired audience characteristic.

At 910, the ad server 130 determines whether the totality of survey responses received for users associated with the determined audience segment represents a statistically significant result. In at least some embodiments, the ad server 130 samples users of audience segments to survey a subset of users from those audience segments. The ad server 130 may determine whether a statistically significant result by comparing the number of received survey responses for a given audience segment to a pre-determined threshold, for example, as found in characterization guidelines described in Table 1 below.

If the ad server 130 determines a statistically significant result has not been reached, at 912, the ad server 130 may save the survey result in storage for later recall. In some embodiments, the ad server 130 stores the survey result to compile with later received survey responses. The ad server 130 may then loop and return to 902 to wait for contact from other users to provide survey queries and/or ad content.

If the ad server 130 determines that a statistically significant result has been reached, at 914, then the ad server 130 updates one or more campaign parameters based on the composition score of the audience segment. In one embodiment, the ad server 130 determines a change to the campaign parameters such that brand advertising is allocated to the audience segment based on the audience segment's composition score. In one embodiment, the ad server 130 may update a campaign parameter to allocate an amount of campaign resources to the audience segment proportional on the corresponding composition score of the audience segment. For example, the ad server 130 may update one or more campaign parameters to increase a percentage share of campaign ad impressions for an audience segment having a higher composition score compared to other audience segments.

At 916, the ad server 130 selects an ad for the user based on the user profile and on the one or more updated campaign parameters. As noted above, the campaign parameters may include an audience profile having one or more targeted characteristics that indicate the target audience for a given advertising campaign. In some embodiments, the ad server may select an ad from a given advertising campaign in which the user is a member of the target audience and in which the audience segment of the user has increased campaign ad impressions based on the campaign parameters updated at 914.

As shown, the ad server 130 then proceeds to loop back and return to 902 to wait for contact from other users to provide survey queries and/or ad content. It is appreciated that composition scores for audience segments are continuously monitored and campaign parameters are continuously updated to reflect changes to the compositions of the audience segments.

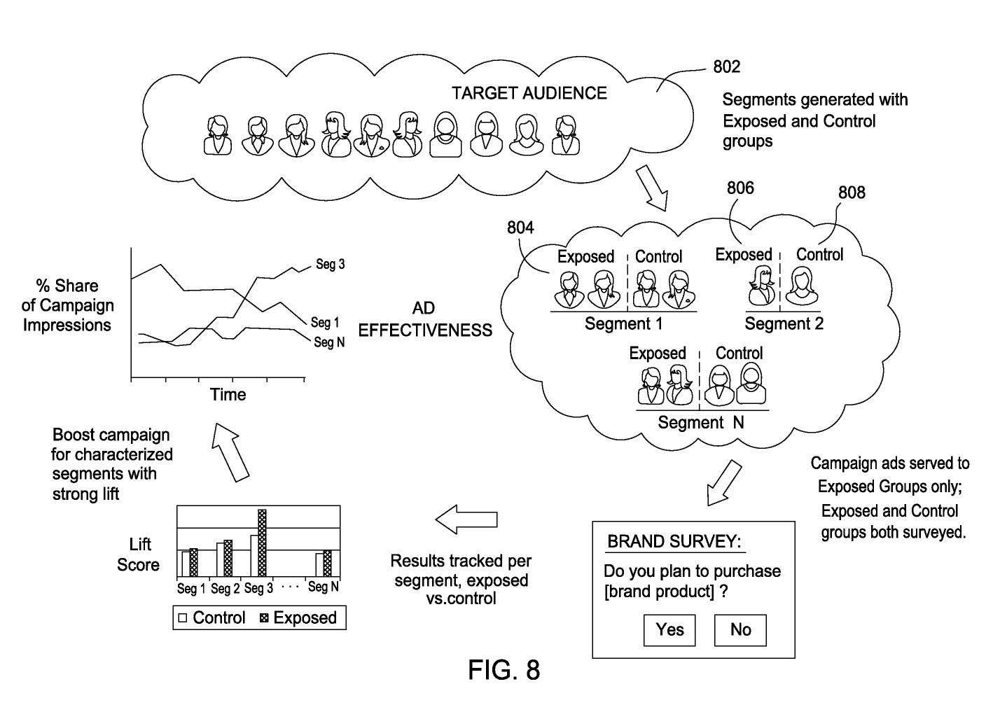

FIG. 8 illustrates one embodiment of the invention for adapting an online advertising campaign utilizing real-time surveys to measure ad effectiveness of a campaign, according to one embodiment of the invention. A brand advertising campaign may have a varied effect across different users. For example, an awareness campaign for a sequel to a previous summer blockbuster movie may generate only a marginal lift in awareness in fans of the previous blockbuster that are eagerly awaiting the release of the sequel. As such, the awareness campaign may have a higher brand impact by targeting users that are not already aware of the sequel's impending release.

Embodiments of the invention provide techniques for adapting an advertising campaign to improve ad effectiveness that is focused on delivering impressions to users to create a maximum brand impact as the impact relates to a specific brand metric and the product/service being advertised.

For ad effectiveness, as in the case of targeting effectiveness, described earlier, a plurality of users comprising a target audience 802 of an advertising campaign may be grouped into one or more audience segments 804. Each audience segment 804 may be statistically sampled and surveyed using an exposed and a control group to measure effectiveness of a particular ad content or ad campaign. In one embodiment, within each audience segment 804, a sample of users may be designated as the “exposed” group 806 that receives advertising from the advertising campaign. Another sample from the remaining users may be designated as the “control” group 808 which does not receive ads from the campaign and instead receives advertising content corresponding to an unrelated message or campaign. The control group 808 may be configured to have a same size and similar attributes as the exposed group 806 so as to allow both groups to be comparable. In one embodiment, the control group 808 may have similar demographic profiles, geographic dispersion, interests, shopping patterns, and previous category & brand buying behavior as the exposed group 806.

As illustrated, users in both the exposed group 806 and the control group 808 are surveyed to calculate one or more brand metrics to determine the brand impact of the advertising campaign. In one embodiment, the one or more brand metrics are measured dynamically. In one implementation, a real-time survey is selected that relates an advertised product/service and a brand metric of interest. As noted above, the survey question may be selected to measure brand awareness, unaided message association, aided message association, purchase consideration, brand favorability, intent to purchase, recommendation intent, familiarity, and other brand metrics. Examples of a survey question to measure a brand metric include: “Have you heard of [brand/product]?”, “Which [brand/product] do you like best?”, “Are you aware that [brand/product] is [message]?”, “Do you plan to purchase [brand/product?”, and “Would you recommend [brand/product]?”

As illustrated, survey results are collected to track the brand metric for users in the control group as well as exposed group for each audience segment. Brand impact may be evaluated based on a “lift” in the brand metric of the exposed group 806 over the control group 808. In one embodiment, for each segment 804, the survey results may be analyzed to calculate a lift score that indicates a difference between the brand metric of the exposed group 806 (which was exposed to the advertising campaign) and the brand metric of the control group 808 (which was not) that reflects a brand impact of the advertising campaign on the given segment 804.

As with targeting effectiveness, the target audience may be sample surveyed. As such, an audience segment may be deemed “characterized” when a statistically significant number of survey responses has been collected for both the exposed and control groups of a given audience segment. In one embodiment, each characterized segment may be associated with a lift score and statistics parameters such as confidence level and error rate. In one embodiment, survey responses may be weighted to ensure that there are no biases and to account for any skews between the test and control groups. For example, the survey responses may be weighted to remove a male/female bias in a sample of surveyed users having a disproportionate number of male users.

As the advertising campaign is executed, the advertising campaign may be optimized to deliver ad impressions to audience segments based on the corresponding lift score. In one embodiment, the advertising campaign may be adapted mid-campaign to deliver an increased number of ad impressions to audience segments with a corresponding higher lift score (i.e., segments that have felt a demonstratively greater effect from the advertising campaign). As with targeting effectiveness, new segments that are added to the campaign may be characterized and then scaled appropriately. Characterized segments that have been scaled up may continue to be monitored to ensure that their lift score remains high.

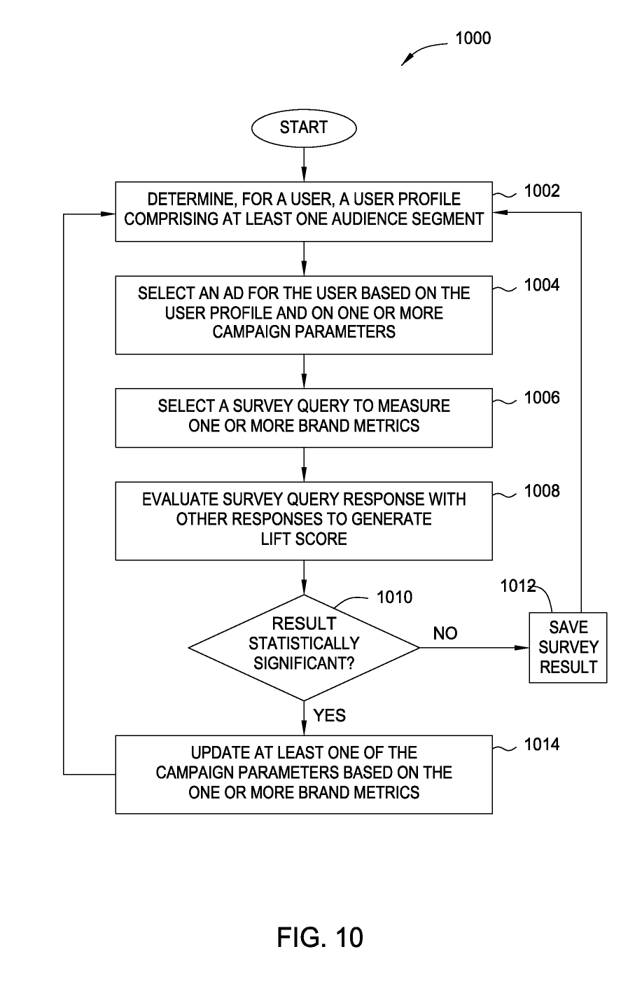

The example operations of the ad server 130 for adapting an online advertising campaign based on ad effectiveness are discussed in greater detail in FIG. 10. FIG. 10 is flow diagram of method steps 1000 for serving brand advertising to a user utilizing a technique for real-time adaptation based on ad effectiveness, according to one embodiment of the invention. Persons skilled in the art will understand that, even though the method 1000 is described in conjunction with the systems of FIGS. 1-2, any system configured to perform the method steps, in any order, is within the scope of embodiments of the invention.

As shown, the method 1000 begins at 1002, where the ad server 130 determines the user profile for a given user that identifies the audience segment associated with the user. As described above, each of a plurality of users may be assigned to a given audience segment to analyze the impact of the advertising campaign with a degree of granularity. In one embodiment, the audience segment may include a set of users grouped based on an audience characteristic. In other embodiments, the audience segment may be based on the media channel, the context, or other attributes.

As described above, each audience segment may be statistically sampled and surveyed using an exposed and a control group to measure ad effectiveness. In one embodiment, the ad server 130 determines the user profile of a given user indicates that the user is a member of an exposed group of users in the audience segment that receives advertising from the online advertising campaign undergoing adaptation. Alternatively, the ad server 130 may determine the user profile indicates the user is a member of a “control” group of users in the audience segment which does not receive ads from the campaign and instead receives advertising content corresponding to an unrelated message or campaign.

At 1004, the ad server 130 selects an ad for the user based on the user profile and on one or more campaign parameters. As noted above, the campaign parameters may include an audience profile having one or more targeted characteristics that indicate the target audience for a given advertising campaign. In some embodiments, the ad server may select an ad from a given advertising campaign in which the user is a member of the target audience. In one embodiment, the ad server 130 selects ad content for the user based on whether the user is in an exposed group or in a control group of the audience segment.

At 1006, the ad server 130 selects a survey query, for the user, to measure one or more campaign metrics. As described above, the ad server 130 may select a survey query for only a subset of users being sampled to measure the one or more campaign metrics. In one embodiment, the one or more campaign metrics are one or more brand metrics that represent a user's brand awareness, unaided message association, aided message association, purchase consideration, brand favorability, intent to purchase, recommendation intent, and/or familiarity. In one embodiment, the one or more campaign metrics are indicative of an impact of the advertising on the user. The survey query may be pre-determined and stored in a storage unit of the ad server.

At 1008, the ad server 130 receives the response to the survey query and proceeds to evaluate a response to the survey query with other survey responses associated with the user's audience segment to generate a survey result comprising a lift score. In at least some embodiments, the ad server 130 determines, for the audience segment corresponding to the user, a lift score corresponding to an impact of the advertising on the user associated with the audience segment. In one embodiment, for a particular audience segment, the ad server 130 determines a lift score of the audience segment that represents a difference or ratio between a brand metric measured for the exposed group and a corresponding brand metric for the control group. In one embodiment, there may be no users in the control group for any audience segment and the lift score is determined by the average value of the brand metric measured for the exposed group.

At 1010, the ad server 130 determines whether the totality of survey responses represents a statistically significant result. In some embodiments, because the survey response are sampled from a subset of the target audience, the ad server 130 may determine whether a statistically significant result by comparing the number of received survey responses to a pre-determined threshold, for example, as found in characterization guidelines described in Table 1 below.

If the ad server 130 determines a statistically significant result has NOT been reached, at 1012, the ad server 130 may save the survey result in storage for later recall. In some embodiments, the ad server 130 stores the survey result to compile with later received survey responses. The ad server 130 may then loop and return to 1002 to wait for contact from other users to serve advertising. If the ad server 130 determines that a statistically significant result has been reached, at 1014, then the ad server 130 determines a change in at least one of the campaign parameters responsive to the one or more campaign metrics measured by the survey results. In at least some embodiments, the ad server 130 may update at least one of the campaign parameters for the audience segment associated with the user based on a determined lift score of the audience segment. For example, the ad server 130 may increase an allocation of campaign resources for an audience segment having a high lift score to reflect the determined effectiveness of the advertising campaign on the audience segment.

Embodiments of the invention provide characterization guidelines for determining a minimum number of survey responses required across different confidence intervals, error rates, and probabilities for selecting a preferred option. For example, characterization guidelines may stipulate that a minimum of 4,432 survey responses may be needed to reach a 50% confidence level in a survey option that has a probability of being selected 20%+/−2% of the time. Table 1, found below, illustrates one example of a table of sample characterization guidelines indicating a minimum survey responses required to characterize an audience segment with a particular confidence level (CL), error rate (Err), and a probability for a preferred survey response option (Pr):

TABLE 1
Sample Characterization Guidelines

| CL | Err | Pr | Min. Survey Responses Required |
|---|---|---|---|
| 50% | 2% | 20% | 4,432 |
| 50% | 2% | 25% | 3,350 |
| 50% | 2% | 30% | 2,500 |
| 50% | 2% | 35% | 2,000 |
| 50% | 2% | 40% | 1,625 |

Further, the characterization guidelines may indicate how much to sample the ad recipients for surveying. In other words, the characterization guidelines may indicate how many users may be surveyed (i.e., survey impression) out of the total number of users that received the campaign ads (i.e., ad impression). In one embodiment, for targeting effectiveness based adaptive campaigns, five percent of the impressions of a campaign may be selected for showing survey impressions. These survey impressions may be assigned to a bonus pool of impressions associated with the advertising campaign. For example, for a $100,000 campaign with a cost per impression (CPM) of $5, approximately 1 million survey impressions may be served. Assuming a 0.2% survey response rate (SRR), 60% confidence interval (CI), and composition indexes varying from 50%-70%+/−5%, embodiments of the invention may characterize about ten different segments.

In another embodiment, for ad effectiveness based adaptive campaigns, five to ten percent of the total campaign impressions may be used to show survey impressions. As such, for a $100,000 campaign, with a CPM of $5, embodiments of the invention allow for delivery of approximately 1,000,000 to 2,000,000 survey impressions. Assuming a 0.2% survey response rate (SRR), 50% confidence interval (CI), and a probability of about 30%+/−5% for a preferred response option, embodiments of the invention may characterize about five to six different segments.

Additionally, it is contemplated that some embodiments of the invention may implement a model-based approach instead of a segment-based approach. As described, in a segment-based approach, those segments that exhibit a positive response are scaled up and those segments that exhibit a negative response are scaled down. In a model-based approach, a propensity score is calculated for each user to which the ad is displayed. The propensity score may be associated with a probability that the user will respond to the survey and/or a prediction of how the user will respond to the survey. In one embodiment, the propensity score may comprise one of three values, including a positive score, a negative score, or a neutral score. In other embodiments, any technically feasible scoring system may also be implemented. In a model-based approach, there is no concept of segments. Rather, a data mining model tracks responses to survey questions and learns to predict the propensity score described above. In some embodiments, implementing a model-based approach provides more refined results compared to implementing a segment-based approach since the model-based approach mines data at the individual level rather than at the segment level. For example, while a first segment may score relatively more favorably than a second segment on the average, there may be many individuals in the first segment that do not score favorably. A model based approach is more fine grained and is able to boost performance further (as compared to a segment-based one) by only focusing on individuals who score favorably.

It is also contemplated that embodiments of the invention described above may be extended to utilize alternative techniques for measuring impact of the advertising campaign on one or more brand metrics. In addition to real-time surveys, the impact of the ad campaign on one or more brand metrics can be measured based on dwell time, i.e., how long an ad is visible on a webpage, or the user's engagement with the ad unit. In still further embodiments, the impact of the ad campaign on one or more brand metrics can be measured using any technically feasible technique or combination of techniques. It is further noted that embodiments of the invention may be operated to concurrently manage multiple advertising campaigns according to the techniques described herein.

Also, in some embodiments, the updates to the campaign parameters may be static (i.e., manual) or dynamic (i.e., automatic). In one embodiment, the campaign parameters may be based on “segments” of individuals. After a campaign metric, such as brand impact, is measured, a particular group of individuals or segments may be identified as responding positively to the ad campaign. Based on this identification, the campaign parameters are updated. Updating the campaign parameters may be done manually by a person that reviews the data or automatically by a software program configured to determine positive responses based on the lift in the particular metric being analyzed. In one embodiment, the “lift,” or increase, in a metric (across exposed and control groups) is used to identify positive responses to the ad campaign, and not the absolute value of the metric. In another embodiment the absolute value of a brand metric such as audience composition or any other relevant metric could be used to identify high performing segments for the ad campaign.

Accordingly, embodiments of the invention may dynamically tune the ad campaign to focus on users who are more likely to engage with the brand and/or to respond to the desired message. Embodiments of the invention advantageously allow for a steady lift in one or more brand metrics during the course of the advertising campaign, which provides faster and more targeted results since the adapted campaign parameters are based on leading indicators, and not lagging indicators as in conventional techniques. Accordingly, those individual users or audience segments that may respond well to the advertising campaign may be scaled up (i.e., served additional impressions), and those individuals or audience segments that may respond poorly may be scaled down.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A method for implementing a brand-based ad campaign, comprising:
providing advertising to a plurality of users based on one or more campaign parameters;
providing one or more survey queries to the plurality of users, wherein the survey queries are selected to measure one or more campaign metrics; and
processing, by operation of one or more processing units, responses to the survey queries to update the one or more campaign parameters based on the measured campaign metrics.

2. The method of claim 1, wherein the one or more campaign metrics are indicative of an impact of the advertising on at least one of the plurality of users.

3. The method of claim 1, further comprising:
partitioning the plurality of users into one or more audience segments based on an audience characteristic, and
determining, for each audience segment, a lift score corresponding to an impact of the advertising on a set of users associated with the audience segment.

4. The method of claim 3, wherein each audience segment comprises an exposed group comprising a first set of users delivered advertising from the ad campaign, and a control group comprising a second set of users not delivered advertising from the ad campaign; and wherein the method further comprises:
determining a statistically significant comparison of a brand impact on the exposed group and a brand impact on the control group.

5. The method of claim 3, wherein the processing responses to the survey queries comprises:
allocating brand advertising to the users of the audience segments based on a determined lift score associated with each audience segment.

6. The method of claim 1, wherein the one or more campaign metrics is selected from a group comprising brand awareness, message association, unaided message association, aided message association, purchase consideration, brand favorability, intent to purchase, recommendation intent, and familiarity.

7. The method of claim 1, wherein the one or more campaign metrics are indicative of a frequency of the plurality of users having a desired audience characteristic.

8. The method of claim 1, wherein the method further comprises:
partitioning the plurality of users into one or more audience segments; and
determining, for each audience segment, a composition score corresponding to a percentage of users in the audience segment having a target audience characteristic.

9. The method of claim 8, wherein the processing responses to the survey queries to update the one or more campaign parameters comprises:
allocating brand advertising to users of audience segments having a higher composition score than other audience segments.

10. A method for executing an advertising campaign to an audience comprising a plurality of users, the method comprising:
processing a plurality of user responses to generate one or more campaign metrics, wherein the plurality of user responses are responsive to one or more survey queries provided to the plurality of users; and
modifying, by operation of one or more processing units, one or more campaign parameters of the advertising campaign based on the generated campaign metric.

11. A method for adapting an advertising campaign, comprising:
determining an audience segment for a user;
selecting an ad for the user based on the audience segment and on one or more campaign parameters;
selecting a survey query to provide to the user;
processing a response to the survey query using the audience segment to generate one or more campaign metrics; and
updating, by operation of one or more processing units, at least one of the campaign parameters based on the one or more campaign metrics.

12. The method of claim 11, wherein the one or more campaign metrics include at least one of brand or audience composition metrics.

13. A computer-readable storage medium storing instructions that, when executed by a processor, performs an operation for executing an advertising campaign, the operation comprising:
providing advertising to a plurality of users based on one or more campaign parameters;
providing one or more survey queries to the plurality of users, wherein the survey queries are selected to measure one or more campaign metrics; and
processing, by operation of the processor, responses to the survey queries to update the one or more campaign parameters based on the measured campaign metrics.

14. The computer-readable storage medium of claim 13, wherein the one or more campaign metrics are indicative of an impact of the advertising on at least one of the plurality of users.

15. The computer-readable storage medium of claim 13, wherein the operation further comprising:
partitioning the plurality of users into one or more audience segments based on an audience characteristic, and
determining, for each audience segment, a lift score corresponding to an impact of the advertising on a set of users associated with the audience segment.

16. The computer-readable storage medium of claim 15, wherein each audience segment comprises an exposed group comprising a first set of users delivered advertising from the ad campaign, and a control group comprising a second set of users not delivered advertising from the ad campaign; and wherein the operation further comprises:
determining a statistically significant comparison of a brand impact on the exposed group and a brand impact on the control group.

17. The computer-readable storage medium of claim 15, wherein the operation further comprises:
allocating brand advertising to the users of the audience segments in an amount corresponding to based on a determined lift score associated with each audience segment.

18. The computer-readable storage medium of claim 13, wherein the one or more campaign metrics is selected from a group comprising brand awareness, message association, unaided message association, aided message association, purchase consideration, brand favorability, intent to purchase, recommendation intent, and familiarity.

19. The computer-readable storage medium of claim 13, wherein the one or more campaign metrics are indicative of a frequency of the plurality of users having a desired audience characteristic.

20. The computer-readable storage medium of claim 13, wherein the operation further comprises:
partitioning the plurality of users into one or more audience segments; and
determining, for each audience segment, a composition score corresponding to a percentage of users in the audience segment having a target audience characteristic.

21. The computer-readable storage medium of claim 20, wherein the operation further comprises:
allocating brand advertising to users of audience segments having a higher composition score than other audience segments.

22. A computer-readable storage medium storing instructions that, when executed by a processor, performs an operation for executing an advertising campaign to an audience comprising a plurality of users, the operation comprising:
processing a plurality of user responses to generate one or more campaign metrics, wherein the plurality of user responses are responsive to one or more survey queries provided to the plurality of users; and
modifying, by operation of the processor, one or more campaign parameters of the advertising campaign based on the generated campaign metric.

23. A computer-readable storage medium storing instructions that, when executed by a processor, performs an operation for adapting an advertising campaign, the operation comprising:
determining an audience segment for a user;
selecting an ad for the user based on the audience segment and on one or more campaign parameters;
selecting a survey query to provide to the user;
processing a response to the survey query using the audience segment to generate one or more campaign metrics; and
updating at least one of the campaign parameters based on the one or more campaign metrics.

24. The computer-readable storage medium of claim 23, wherein the one or more campaign metrics include at least one of brand or audience composition metrics.

25. A system, comprising:
a storage device configured to store one or more campaign parameters and a plurality of survey responses, and
an ad server configured to:
provide advertising to a plurality of users based the one or more campaign parameters,
provide one or more survey queries to the plurality of users, wherein the survey queries are selected to measure one or more campaign metrics, and
process responses to the survey queries to update the one or more campaign parameters based on the measured campaign metrics.
